(19) United States
(12) Patent Application Publication
(10) Pub. No.: US 2014/0095668 A1
(43) Pub. Date: Apr. 3, 2014

(54) METHOD FOR SEAMLESS UNICAST-BROADCAST SWITCHING DURING DASH-FORMATTED CONTENT STREAMING

(71) Applicant: Ozgur Oyman, San Jose, CA (US)

(72) Inventor: Ozgur Oyman, San Jose, CA (US)

(21) Appl. No.: 13/929,151

(22) Filed: Jun. 27, 2013

Related U.S. Application Data
(60) Provisional application No. 61/707,784, filed on Sep. 28, 2012.

(51) Int. Cl. H04L 29/08

(52) U.S. Cl. CPC H04L 67/10
USPC 709/219

(57) ABSTRACT

A method for switching from a unicast based delivery to an evolved multimedia broadcast multicast services (eMBMS) based delivery of dynamic adaptive streaming over hyper-text transfer protocol (HTTP) (DASH) formatted content. The method can include inserting dedicated stream access points (SAPs) in media for switching between the unicast and eMBMS-based content delivery. The use of SAPs enables a DASH client to be able to seamlessly switch between unicast and broadcast delivery modes.

### RELATED APPLICATIONS

This application claims the benefit of and hereby incorporates by reference U.S. Provisional Patent Application Ser. No. 61/707,784, filed on Sep. 28, 2012 with a docket number of P49082Z.

### BACKGROUND

Hyper Text Transfer Protocol (HTTP) streaming is a widely used form of multimedia delivery of Internet video. HTTP-based multimedia delivery provides reliability and deployment simplicity due to the broad adoption of both HTTP and its underlying Transmission Control Protocol/Internet Protocol (TCP/IP) protocols. Additionally, HTTP-based multimedia delivery enables easy and effortless streaming services by avoiding network address translation (NAT) and firewall traversal issues. HTTP-based streaming also provides the ability to use standard HTTP servers and caches instead of specialized streaming servers and has better scalability due to minimal state information on the server side.

One method of streaming multimedia content over the Internet is to use real time streaming protocol (RTSP)-based adaptive streaming. RTSP can be a network control protocol used in entertainment and communications systems to control streaming media servers. The RTSP protocol can be used for establishing and controlling media sessions between end points in a push-based and server controlled fashion.

Another method of viewing multimedia content over the Internet is HTTP Progressive downloading, which is also available for media delivery from standard HTTP Web servers. Clients that support HTTP-based progressive download can seek positions in the media file by performing byte range requests to the Web server. However, HTTP-based progressive downloading can also include several disadvantages, including: (i) bandwidth may be wasted if the user decides to stop watching the content after a progressive download has started (e.g., switching content), (ii) progressive downloading is not bitrate adaptive, (iii) progressive downloading does not support live media services, and (iv) progressive downloading introduces random amounts of latency in packet delivery, thereby using buffering to be implemented and causing interruption in playback.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 is a timeline diagram illustrating an embodiment of a dynamic adaptive streaming over (DASH) client changing between the unicast connection and the multicast connection at a SAP of the streaming data in accordance with an example;

FIG. 2 is a timeline diagram illustrating an embodiment of a DASH client changing between the unicast connection and a plurality of alternating multicast connections at SAPs of the streaming data in accordance with an example;

FIG. 3 is an illustration representing a data stream switching from a unicast connection to a plurality of multicast connections in accordance with an example;

FIG. 4 is a timeline diagram illustrating an embodiment of a DASH client changing between the unicast connection and multicast connections A and B in accordance with an example;

FIG. 5 is an illustration representing a data stream switching between a unicast connection and a plurality of standard definition (SD) and high definition (HD) multicast connections in accordance with an example;

FIG. 6 is a timeline diagram illustrating an embodiment of a DASH client changing between two multicast connections at SAPs of the streaming data in accordance with an example;

FIG. 7 is an illustration representing a data stream switching between a plurality of multicast connections in accordance with an example;

FIG. 8 is a flow chart illustrating a DASH client changing between a unicast and multicast connection in accordance with an example;

FIG. 9 is a flow chart illustrating the switching from receiving a media stream over a unicast connection to receiving the media stream over a multicast connection at a DASH client in accordance with an example;

FIG. 10 is a flow chart illustrating the switching from receiving a media stream over a multicast connection to receiving the media stream over a different multicast connection at a DASH client in accordance with an example;

FIG. 11 is a block diagram illustrating an embodiment of a communication between unicast and multicast servers and a user equipment (UE) in accordance with an example;

FIG. 12 is a block diagram illustrating an embodiment of a communication between a media server and a UE in accordance with an example;

FIG. 13 is a flow chart illustrating a method for inserting stream access points in data in accordance with an example;

FIG. 14 is a block diagram illustrating an embodiment of a media server providing a UE with multimedia content in accordance with an example; and

FIG. 15 illustrates a diagram of a user equipment (UE) in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

Hypertext transfer protocol (HTTP) streaming is a form of multimedia delivery of internet video and audio content—referred to as multimedia content, media content, media services, or the like. In HTTP streaming, a multimedia file can be partitioned into one or more segments and delivered to a client using the HTTP protocol. HTTP-based multimedia content delivery (streaming) provides for reliable and simple content delivery due to broad previous adoption of both HTTP and its underlying protocols, Transmission Control Protocol/Internet Protocol (TCP/IP). HTTP-based delivery can enable easy and effortless streaming services by avoiding network address translation (NAT) and firewall traversal issues. HTTP-based delivery of streaming data can also provide the ability to use standard HTTP servers and caches instead of specialized streaming servers. HTTP-based delivery can provide scalability due to minimal or reduced state information on a server side. Examples of HTTP streaming technologies can include Microsoft IIS Smooth Streaming, Apple HTTP Live Streaming, and Adobe HTTP Dynamic Streaming.

Dynamic adaptive streaming over HTTP (DASH) is an adaptive multimedia streaming technology where a multimedia file can be partitioned into one or more segments and delivered to a client using HTTP. DASH specifies formats for a media presentation description (MPD) metadata file that provides information on the structure along with different versions of the media content representations stored in the server as well as the segment formats. For example, the metadata file contains information on the initialization and media segments for a media player (the media player looks at initialization segment to understand container format and media timing info) to ensure mapping of segments into media presentation timeline for switching and synchronous presentation with other representations. A DASH client can receive multimedia content by downloading the segments through a series of HTTP request-response transactions. DASH can provide the ability to dynamically switch between different bit rate representations of the media content as the available bandwidth changes. Thus, DASH can allow for fast adaptation to changing network and wireless link conditions, user preferences and device capabilities, such as display resolution, the type of computer processor employed, or the amount of memory resources available. DASH is one example technology that can be used to address the weaknesses of Real time protocol (RTP) and RTSP based streaming and HTTP-based progressive download. DASH based adaptive streaming, which is standardized in Third Generation Partnership Project (3GPP) technical specification (TS) 26.247 releases, including Releases 10, 11 and 12, and the Moving Picture Experts Group (MPEG) ISO/IEC DIS 23009-1, is an alternative method to RTSP based adaptive streaming.

In DASH, a media presentation description (MPD) metadata file provides information on the structure and different versions of the media content representations stored in the server. A representation may be an alternative to a complete set or subset of the multimedia content components for a given period of time. A representation may start at the beginning of a period, continue to the end of the period, or start at the end of the MPD. A representation may include one or more multimedia streams. Each multimedia stream may be an encoded version of one multimedia content component. A representation may consist of one or more segments. A representation may contain an initialization segment or a multimedia segment. A representation may be self-initializing, where a segment may conform to a specified or defined media type for the representation.

In DASH, a client may switch from representation to representation within an adaptation set at any time in the media content. An adaption set may contain one or more representations. The clients may switch from one representation to another representation within the adaption set based on different multimedia content properties or attributes. The different multimedia properties or attributes may include: languages, multimedia content types, roles, accessibility, viewpoints, ratings, bandwidth, video width, video height, and frame rate. The values of the multimedia properties or attributes may be provided within the adaption set for the one or more representations. Adaption sets may be arranged into groups based on group properties or attributes.

However, switching at arbitrary positions may be complicated because of coding dependencies of codecs used to compress media within representations and other factors. It is desirable to avoid download of ‘overlapping’ data i.e. media for the same time period from multiple representations. Usually, switching is simplest at a random access point in the new stream. In order to formalize requirements related to switching, DASH can define a codec-independent concept of a Stream Access Point (SAP) and identify various types of Stream Access Points. A SAP is a temporally-independent position in a representation that enables playback of a media stream to be started using only the information contained in representation data starting from the position of the SAP onwards (preceded by initializing data in the Initialization Segment, if any).

A number of different versions of media can be stored in a server including versions with: different bitrates, frame rates, resolutions, codec types, and so forth, as previously discussed. DASH also specifies the segment formats, i.e., containing information on the initialization and media segments for the media engine. The media engine can look at an initialization segment to understand a container format and media timing information. DASH segment formatting can be used for mapping of segments into a media presentation timeline for switching and synchronous presentation with other representations.

DASH allows for continuous playback of streaming media on a mobile wireless device even with changes that may occur in content quality, bit rate, frame rate, resolution, or other parameters when the segments from the server are streamed to the mobile wireless device.

Based on the MPD metadata information that describes the relation of the segments and how they form a media presentation, a client, operating on a mobile wireless device, such as a user equipment (UE) or mobile station (MS), can request the segments using a command such as an HTTP GET or a partial GET method. The client can control the streaming session. For example, the client can manage the on-time request and smooth playout of the sequence of segments by potentially adjusting bitrates, compression types, frame rates, or other desired attributes. The attributes may be changed, for instance, to react to changes of the device state or the user preferences.

Additionally, DASH provides the ability to dynamically switch between different bitrate representations of the media content as the available bandwidth or wireless link quality changes. Hence, DASH allows faster adaptation to changing network and wireless link conditions, user preferences and device capabilities (e.g., display resolution, CPU, memory resources, etc.). Such dynamic adaptation provides better user quality of experience (QoE), with shorter startup delays and fewer rebuffering events.

Multimedia Broadcast Multicast Services (MBMS), which specified in 3GPP TS 26.346 releases, including Releases 6-12, is a point-to-multipoint system utilized on cellular networks operating in accordance with one of the cellular standards promulgated by the 3GPP. It is designed for efficient delivery of popular content to many receivers based on broadcast and multicast techniques and was first introduced in release six of the 3GPP Universal Mobile Telecommunications System (UMTS) specification as an optional feature. MBMS was further optimized in the later 3GPP releases based on several enhancements such as multicast broadcast single frequency network (MBSFN) functionality. At the service layer, MBMS also defines delivery protocols for both streaming of multimedia content and reliable download of files, based on the transport-layer protocol based on the user datagram protocol (UDP), using real-time transmission protocol (RTP) for streaming and File Delivery over Unidirectional Transport (FLUTE) for file delivery. The MBMS access client may receive the media data and metadata from the server, known as the broadcast multicast service center (BMSC), via user service discovery (USD) signaling. MBMS has been adopted as the evolved MBMS (eMBMS) mode in 3GPP-based Long Term Evolution (LTE) standards development corresponding to 3GPP releases eight and onwards.

DASH-formatted content can be delivered to the UE using both MBMS download delivery methods and/or HTTP-based delivery methods. MBMS-based DASH delivery option may not be available in some service areas, in which case those services might be alternatively provided via unicast. In the case of DASH-formatted content delivery over MBMS, FLUTE transport protocol may be used. FLUTE, as defined in the Internet Engineering Task Force (IETF) Request For Comments (RFC) 3926 and RFC 6726 permits to deliver DASH segments over MBMS such that the client observes them being delivered over HTTP/TCP. An HTTP-Uniform Resource Locator (URL) is assigned to each delivered object in FLUTE and the HTTP-URL maps the Segment URLs in the MPD. The UE can identify the received DASH representations based on the comparison of the HTTP URLs contained in the MPD and the URL information included in the FLUTE packets.

HTTP streaming and DASH can be configured as a unicast communication. As the use of 3GPP Long Term Evolution (LTE) networks continue to grow, deployment of evolved multimedia broadcast and multicast services (eMBMS) offers several benefits. One benefit of eMBMS is that multicast download delivery is an attractive service alternative for offloading HTTP-based unicast download delivery. The use of multicast download delivery can be more efficient, especially in regions with a higher density of users such as urban areas, college towns, sporting events, resorts, and so forth.

Different DASH representations may be available over unicast/HTTP and MBMS/FLUTE requiring a switch for accessing different versions of the DASH content. Switching cases between unicast/HTTP and MBMS/FLUTE may occur in these scenarios, including user-initiated content switching with access change as well as application-initiated access change. In summary, it is possible that the client switches between the unicast and multicast/broadcast access methods during the content streaming and moreover certain DASH-formatted components (representations, segments, etc.) may be received over multicast/broadcast and other components may be received over unicast with synchronization at the client.

Given such availability of unicast/HTTP and broadcast/FLUTE access methods for DASH-formatted content, it is important to ensure continuity and consistent user experience for the entire content streaming.

In accordance with one embodiment of the present invention, SAPs can be configured to allow unicast-broadcast switching. A SAP may be used in both unicast and broadcast/multicast delivery environments. For the unicast delivery environment, a single session is established per client to deliver the content. In the case of multiple clients that each want the same media content, a single unicast session can be used for each client. A benefit of unicast is that it provides the ability to adapt each session on a per client basis. However when a plurality of clients want the same content establishing a single session per client can be inefficient, burdensome, and can result in scalability issues with the number of servers delivering the streaming content, as well as wireless network traffic. When there is a plurality of users wanting the same content then a broadcast delivery environment can be desirable.

For 3GPP configured devices, eMBMS provides a standardized protocol for broadcast delivery. Broadcast delivery provides a standardized method for relaying content to a plurality of users without having to establish a single session per client. However, in some environments and/or locations, broadcast content delivery may not be available. Broadcast providers may only provide broadcast services in locations or environments where a sizeable of users or clients are located. Such locations may include locations such as airports, shopping malls, college campuses, etc. Broadcast services can be provided where a relatively large number of clients and/or users often receive content using mobile devices such as smartphones, tablets, laptops, etc.

It is possible for a user to begin receiving streaming content that is unicast in a location or area that does not provide broadcast content delivery and later move to a location where broadcast content delivery is available. Additionally, the link quality may change for a given user or client as they move locations or depending on the network capabilities. In one example, a user device can originally connect to a unicast or broadcast session with lower quality content, such as standard definition content. However, when the user device moves locations or the network load decreases, high quality content such as high definition content can be made available. The high quality content may be provided over a different link or the same link when the link quality improves. The client, user, or user device may then determine to switch over or the user device may automatically switch from a unicast connection to a broadcast connection, such as eMBMS. As clients and users prefer seamless content delivery, seamless switching between unicast and broadcast content delivery methods is desirable.

Different streaming content may be encoded differently depending on such things as content format, quality, resolution, etc. In one embodiment, the streaming content may be video, audio, data, text, images, animation, interactive content, or other types of multimedia content. Depending on the content encoding, different temporal inefficiencies are introduced in the media content. In one embodiment, a service provider, server, or client may take advantage of the temporal inefficiencies, and synchronize switching between unicast and broadcast delivery methods.

The use of eMBMS can provide additional benefits that include enabling support for new non-real-time service types, provisioning of contents that complement eMBMS streaming services, and leveraging the increasing storage capacity on devices. Implementing eMBMS on LTE networks can enhance the performance and usability of its core eMBMS user service features.

In one embodiment, DASH-formatted content can be transmitted using eMBMS download delivery with the file delivery over unidirectional transport (FLUTE) protocol. FLUTE permits delivery of segments over eMBMS such that the client observes them being delivered over HTTP/transmission control protocol (TCP). An HTTP-uniform resource locator (URL) can be assigned to each delivered object in FLUTE and the HTTP-URL can map the Segment URLs in the MPD.

A client, such as a 3GPP LTE configured User Equipment (UE) (Release 8 or later), can identify the received DASH representations based on the comparison of the HTTP URLs contained in the MPD and the URL information included in the FLUTE packets. In DASH, media content may be transcoded or encoded at predefined or desired compression levels. Different compression levels for media that is to be wirelessly communicated may be desirable based on media content, representation, bitrates, frame rates, resolutions, codec types, etc.

A SAP enables access into a container of media stream(s) at the SAP points. A container may contain more than one media stream. Each stream can be an encoded version of continuous media of a certain media type. In one embodiment, an encoder can encode a media data context, comprising a selected number of video frames. A plurality of encoded representations of the media data context can be generated. At least a portion of the input media data context can be included in a first encoded representation. The same portion can also be included in a second encoded representation of the plurality of encoded representations. The first encoded representation can be encoded according to a different set of encoding parameters than is used to encode the second encoded representation. The encoded representations can then be segmented into selected segment sizes for wireless transmission to wireless device, such as a UE, using DASH. At least one SAP can be inserted at a location in a segment of each encoded representation of the input media data context that enables the UE to switch between a unicast delivery of the streaming data and a multicast delivery of the streaming data at the SAP. This will be discussed more fully in the proceeding paragraphs.

As previously discussed, a SAP is a position in the container which enables playback of an identified media stream to be started using only (a) the information contained in the container starting from that position onwards, and (b) possible initialization data from other part(s) of the container.

The DASH standard specifies SAPs for both open-group of pictures (GOP) and closed-GOP random access points. A GOP may define the pattern of frame types used. In one embodiment, a closed GOP does not contain any frame that refers to a frame in the previous or next GOP. An open GOP may have one or more frames that reference the frame in the previous or next GOP. In one embodiment, a closed GOP may contain more frames than an open GOP of the same length. In this embodiment, open GOPs may provide better compression than closed GOPs of the same structure and size.

As used herein, unless otherwise noted, the term SAP, unicast SAP, multicast SAP, or eMBMS SAP refers to a temporally-independent position in a representation that is selected to allow switching between a unicast connection and a multicast connection, such as an eMBMS/FLUTE session, that enables playback of a media stream to be started using only the information contained in representation data starting from the position of the SAP onwards (preceded by initializing data in the Initialization Segment, if any).

In one embodiment, a service provider or server can be configured to provide a client operating on a UE with switching information before the client switches sessions. The switching information may include the availability of unicast and/or broadcast sessions, content quality, bit rates, frame rates, resolutions, etc. The service provider can select the SAP points and communicate them to the client. The client may then determine if or when to switch sessions based on the switching information. By providing the client with switching information before the client switches, the uncertainty of switching and interruptions in playback is avoided. Additionally, overlapping of content delivery is avoided, as the client, server, and/or service provider know before a session switching when the session switching will occur.

For example, a streaming server can be configured to identify that the client will be switching sessions at a predetermined SAP. The server can be further configured so that it does not send or transmit part of a unicast session that the client will also receive over a broadcast session. In one embodiment, a UE can initiate the switching or handing over from a unicast session to a broadcast session or between a plurality of unicast or broadcast sessions. In another embodiment, a UE or client can join or decide to join a broadcast or unicast session at or before a predetermined time. In another embodiment, a UE or client can join or decide to join a broadcast or unicast session at a predetermined time ahead of a next SAP of the session.

In another embodiment, each of the unicast and eMBMS/FLUTE sessions can be independent sessions that may be connected to and decoded by a client, such as a client operating on a UE. In one embodiment, the SAPs in each session can be synchronized or aligned at the same content points of different sessions. As each session is independent, the client does not need to have received or know what occurred during the previous sessions.

In one embodiment, the length of time to switch between sessions depends on how the content is encoded. For example, the length of time for switching between sessions, i.e. the switching time, using SAPs for content with 30 frames per second may be 15 frames, or approximately 0.5 seconds. However, the actual switching time can depend on a number of factors in addition to frames per second, including the type of codec used to compress the media. The switching time may vary from several milliseconds to several seconds.

The encoding of the sessions can be temporally correlated. In order to decode streaming media, certain frames of the temporally correlated media may need to be decoded before decoding other frames. In one embodiment, eMBMS sequencing data can be transmitted in the DASH MPD. In still a further aspect of the embodiment, the eMBMS sequencing data may be transmitted at periodic intervals. This will be discussed more fully in the proceeding paragraphs.

In another embodiment, unicast SAPs and eMBMS SAPs can be used to enable a client, such as a client operating on a UE, to seamlessly switch from initially receiving data over a unicast/HTTP session to receiving the data over one or more synchronized eMBMS/FLUTE sessions.

Seamlessly switching allows a UE to seamlessly receive data without missing a frame of the streaming data. In this embodiment, seamless switching from a unicast delivery to eMBMS delivery can be accomplished using an eMBMS sequencing framework. In this embodiment, the client can receive a first part of the data, such as streaming media, over a unicast/HTTP session and receive the second part of the data/streaming media over one or more eMBMS/FLUTE sessions.

In one embodiment, a plurality of streaming eMBMS/FLUTE sessions may be used. The client, operating on the UE, can receive data across alternating eMBMS/FLUTE sessions based on the eMBMS sequencing framework. The seamless switching is enabled by the plurality of sequenced eMBMS/FLUTE sessions that are synchronized such that one of the plurality of eMBMS/FLUTE sessions can transmit a portion of the second data for a predetermined period of time at any point in time and another one of the plurality of eMBMS/FLUTE sessions can transmit a subsequent portion of the second data. The client can be configured to tune in to the synchronized sequence, thereby preserving the continuity of the DASH streaming. This will be discussed more fully in the proceeding paragraphs.

In another embodiment, SAPs for unicast-broadcast switching can be included in the DASH MPD and may be included with eMBMS sequencing information. Alternatively, sequencing or switching information can also be included in an eMBMS user service description (USD). In one embodiment of the invention, unicast-broadcast switching SAPs can coincide with the existing DASH-level SAPs for random access between different DASH representations. SAP information may also be carried inside the UE over an interface between the DASH client and eMBMS/FLUTE client.

In one embodiment of broadcast content delivery, SAP points may be known a priori to the service provider, server, and/or client operating on the server. However, the SAP points used by a unicast service provider, a server, and/or a client may not correspond with or may not be synchronized with the SAP points of a broadcast service provider or server. In one embodiment, a service provider, server, or client can synchronize the SAPs of the unicast and broadcast provider to provide seamless switching between unicast and broadcast or eMBMS-based content delivery.

Using SAPs in switching from unicast and broadcast or eMBMS-based content delivery allows a server to control the point when a user or client switches between unicast and broadcast delivery methods. In one embodiment, a server or service provider provides to a client or user device a broadcast or eMBMS-based content delivery for a client or user device that switches over to the broadcast or eMBMS connection at a given SAP. By providing the availability of broadcast or eMBMS-based content delivery to a client or user device, connection availability uncertainty and interruption of the playback is significantly reduced or removed. Additionally, the user device or client can avoid fetching content via a unicast connection that it will receive over a multicast or broadcast connection, thus removing content overlap and content delivery inefficiencies.

Several examples and illustrations are described in the proceeding paragraphs regarding the creation and use of SAPs to switch between a unicast and broadcast connection. These examples are not intended to be limiting.

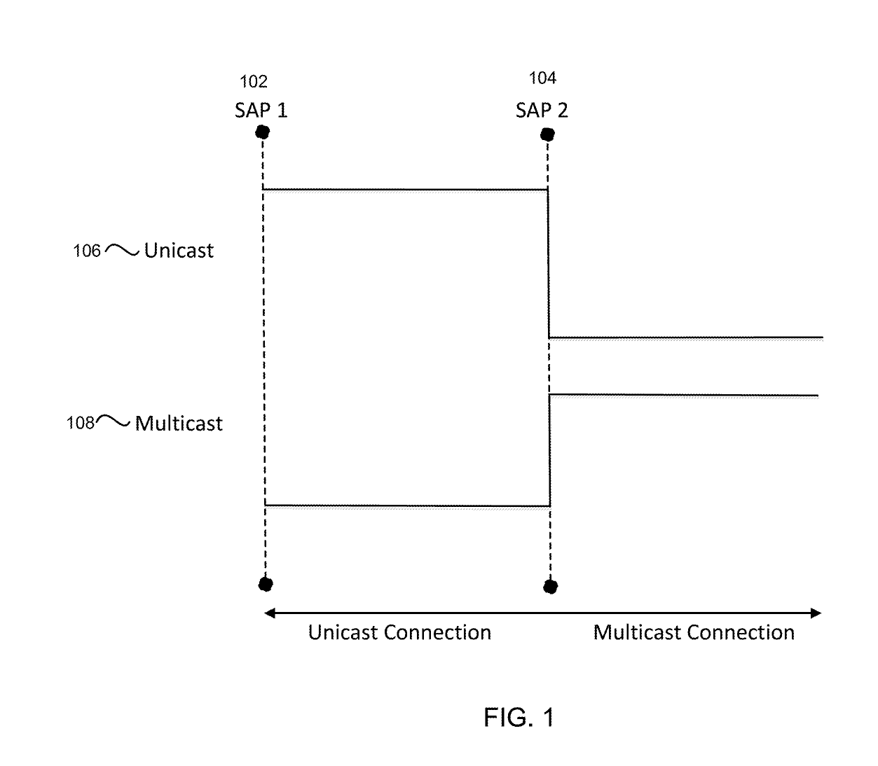

FIG. 1 is a timeline diagram illustrating one embodiment of a DASH client changing between a single unicast connection and a single multicast connection at a SAP of the streaming data. At SAP 1 (102), the UE receives the media stream via the single unicast connection 106. At SAP 2 (104), the UE stops receiving the media stream via the unicast connection 106 and begins receiving the media stream via the single multicast connection 108.

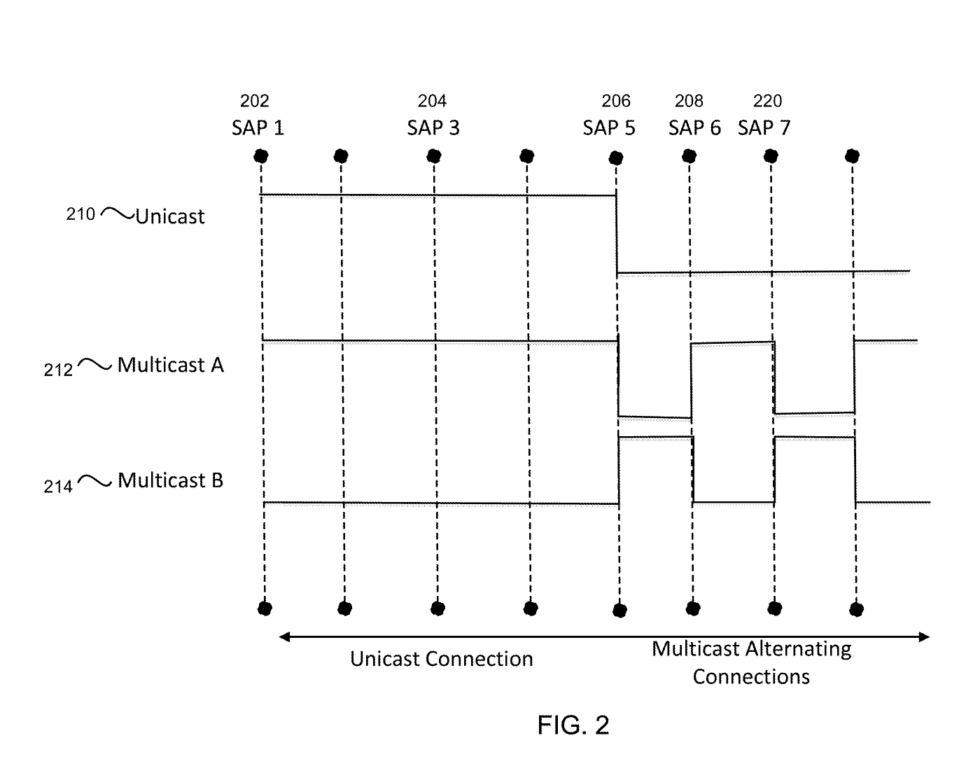

FIG. 2 is an example timeline diagram illustrating another embodiment of a DASH client changing between the unicast connection 210 and two multicast connections, multicast connection A 212 and multicast connection B 214.

At SAP 1 (202) in FIG. 2, the UE or client operating on the UE can receive the media stream via a unicast connection 210. At SAP 5 (206), the UE or client can stop receiving the media stream via the unicast connection 210 and begin receiving the media stream via multicast connection B 214. The UE or client then receives the media stream via alternating multicast connections. In one illustrated example, the UE or client may receive the media stream via multicast connection B between SAP 5 (206) and SAP 6 (208). The UE or client can then switch to receiving the media stream via multicast connection A between SAP 6 (208) and SAP 7 (220). The UE or client may alternate or switch between multicast connections at each SAP, at predefined SAPs, or as the UE or client desires.

In another embodiment, as a client or user moves location or the network load changes there may be different content quality levels available and different quality of links available to the client. Additionally, the link quality can vary between unicast and broadcast sessions and/or between a plurality of broadcast or unicast sessions. In one embodiment, a service provider, server, and/or client may seamlessly switch the content delivered to the best quality available to the client or user based on the link conditions.

In one embodiment a client can switch between a plurality of representations that are available at a server. The client may switch between the representations based on updated information during ongoing media streaming or presentation. In one embodiment, the client may switch from a current representation to a new representation. One example of switching occurs where the client indicates a desire to switch to the server. The server can be configured to locate the next SAP in the new representation. When the server locates the next SAP of the new representation, the server can begin communicating the new representation to the client and the client can use the new representation from the point where the current representation last was presented. Upon switching, the current media streaming or presentation can be closed or terminated. Communicating the current representation up to the SAP and then switching to communicate the new representation enables seamless switching while minimizing errors caused by lost information and energy that may be wasted in transmitting duplicate information.

In one embodiment of the invention, segmentation and sub-segmentation may be performed in order to make switching simpler. For example, each segment or sub-segment can begin with a stream access point and the boundaries of the segments or sub-segments can be aligned across the representations of an Adaptation Set. In this example, a switching representation involves playing the streaming media on a device to the end of a segment or sub-segment of one representation and then playing the streaming media from the beginning of the next segment or sub-segment of the new representation. The MPD and Segment Index provide various indications that describe properties of the representations to enable simpler switching, as previously discussed.

DASH-formatted content may be delivered to the UE using eMBMS download delivery and/or HTTP-based delivery. In one example, multicast delivery is often a more efficient mechanism for streaming multimedia in relatively high density locations, as previously discussed. However, in lower population areas, multicast services may not be available. A user traveling from a high density location to a lower density population area can result in a handover procedure from an eNB that is configured for multicast, such as eMBMS, to an eNB that is configured only for unicast. Switching from multicast to unicast delivery or from unicast to multicast delivery of streaming media may occur in a number of incidences. In addition to handover procedures, changes in a load at an eNB may cause the eNB to change from multicast to unicast, or vice versa.

Accordingly, in one embodiment, when eMBMS-based DASH delivery is not available then streaming media services can be provided to a client via a unicast connection. In another embodiment, eMBMS-based DASH delivery to the client may not initially be available so services can be initially provided via unicast until eMBMS-based DASH delivery becomes available, at which time the DASH-formatted content can be delivered using eMBMS-based DASH delivery. Additionally, a plurality of different DASH representations may be available over unicast/HTTP and/or eMBMS/FLUTE, thereby allowing the client to access and/or the ability to switch between different unicast/HTTP and/or eMBMS/FLUTE DASH representations or different versions of the same representation.

In one embodiment, the streaming data can contain sequencing data. The sequencing data may be contained in a data packet indicating the sequencing information. The sequencing information can include information such as the availability of unicast and/or multicast connections, the ordering of the connections, the length of time each connection will receive the media stream, and/or the connection which the DASH client will initially start receiving the media stream.

For example, the sequencing data may specify that two synchronized sessions, a unicast and a multicast session, will transmit the multimedia stream; that the multimedia stream will initially start transmitting over the unicast connection while the multicast connection is initially idle; and that at a predetermined or defined SAP, the DASH client will switch to a multicast connection. In this example, at the SAP 5 (206), the client is configured to start receiving the media stream over a multicast connection. At the SAP 5 (206) the unicast connection becomes idle or terminates. The DASH client can further establish that the media stream will continue to be received over the multicast session until a predetermined SAP or until the multicast session is no longer available. In one embodiment, the DASH client may request the server to stop transmitting over the unicast connection when switching to a multicast connection.

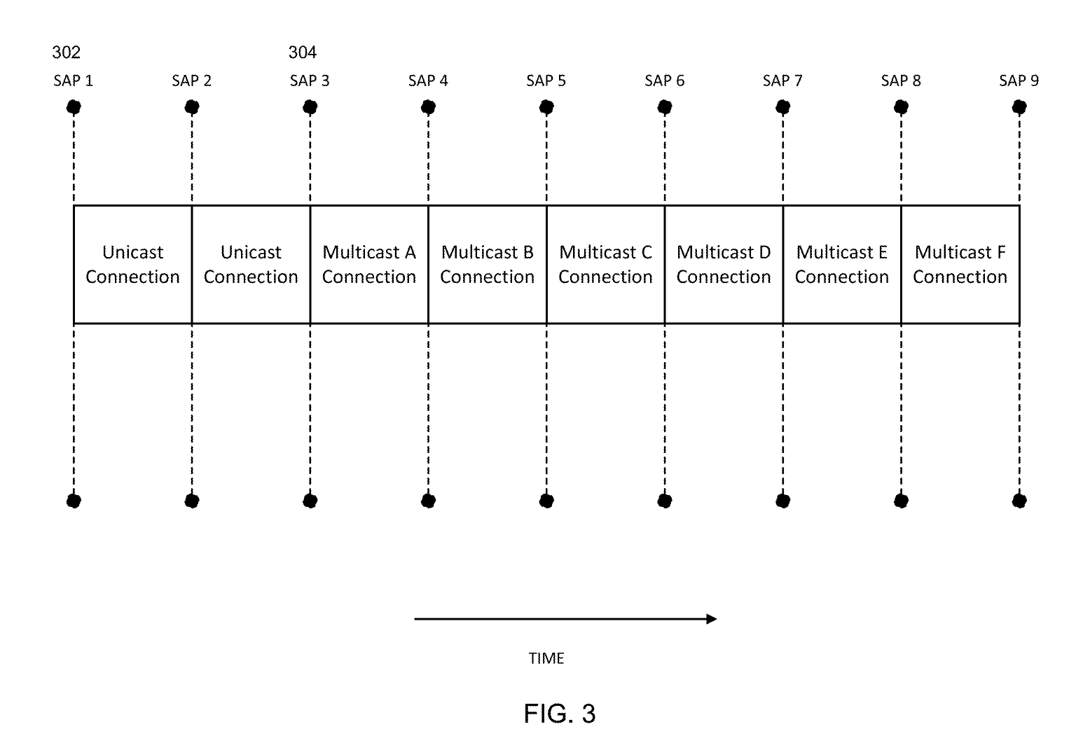

FIG. 3 illustrates changing between a unicast connection and a plurality of multicast connections. At SAP 1 (302), the UE or client can receive the media stream via a unicast connection. At SAP 3 (304), the UE or client can stop receiving the media stream via the unicast connection and begin receiving the media stream via a plurality of multicast connections. In one embodiment, the DASH client may establish that the media stream will continue to be received over the multicast session until a predetermined SAP or the multicast session is no longer available.

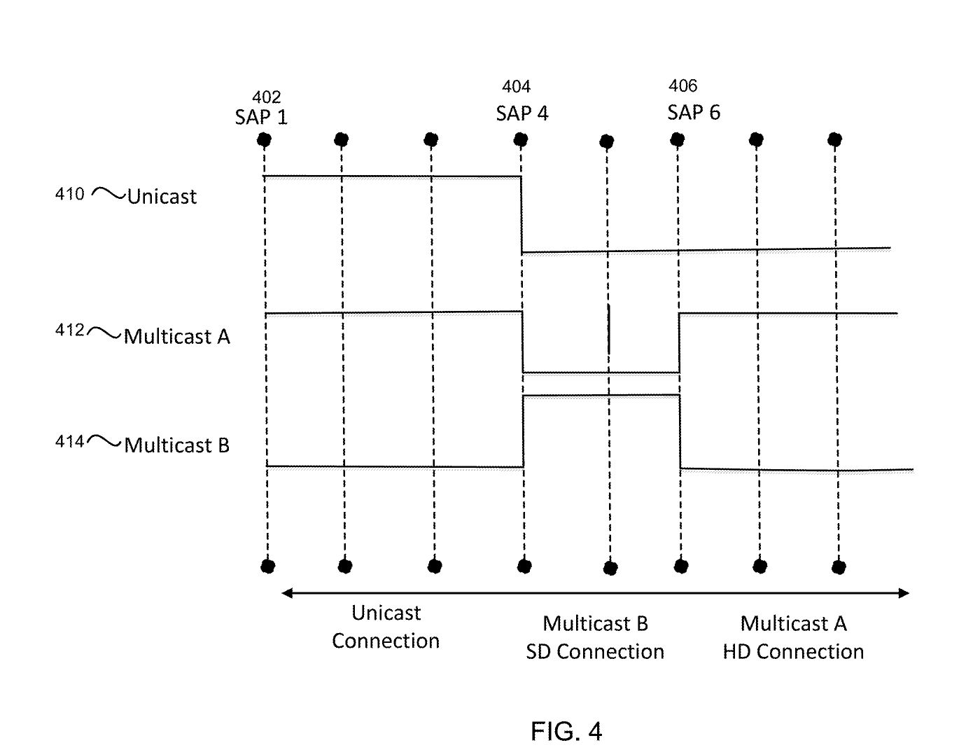

FIG. 4 depicts synchronizing and switching from a unicast/HTTP session to a plurality of eMBMS sessions. FIG. 4 further depicts synchronizing two eMBMS/FLUTE sessions. Switching between unicast/HTTP and eMBMS/FLUTE representations may occur, for example, due a user-initiated content switching with access change as well as an application-initiated access change. In one embodiment, a client or UE can switch between the unicast and broadcast delivery modes during content streaming.

More specifically, FIG. 4 illustrates changing between unicast connection 410 and two multicast connections: multicast connection B 414 and multicast connection A 412. At SAP 1 (402), the UE or client can receive the media stream via a unicast connection 410. At SAP 4 (404), the UE or client can stop receiving the media stream via the unicast connection 410 and begin receiving the media stream via multicast connection B 414. In one embodiment, multicast connection B 414 is a connection for standard definition (SD) resolution media content. The UE or client may receive the SD resolution streaming media content via multicast connection B 414 between SAP 4 (404) and SAP 6 (406). The UE or client may then switch to receiving high definition (HD) resolution streaming media content via multicast connection A 412 at SAP 6 (406). In one embodiment, the UE or client may switch between a multicast resolution connection, such as SD and HD, at each SAP or at predefined SAPs.

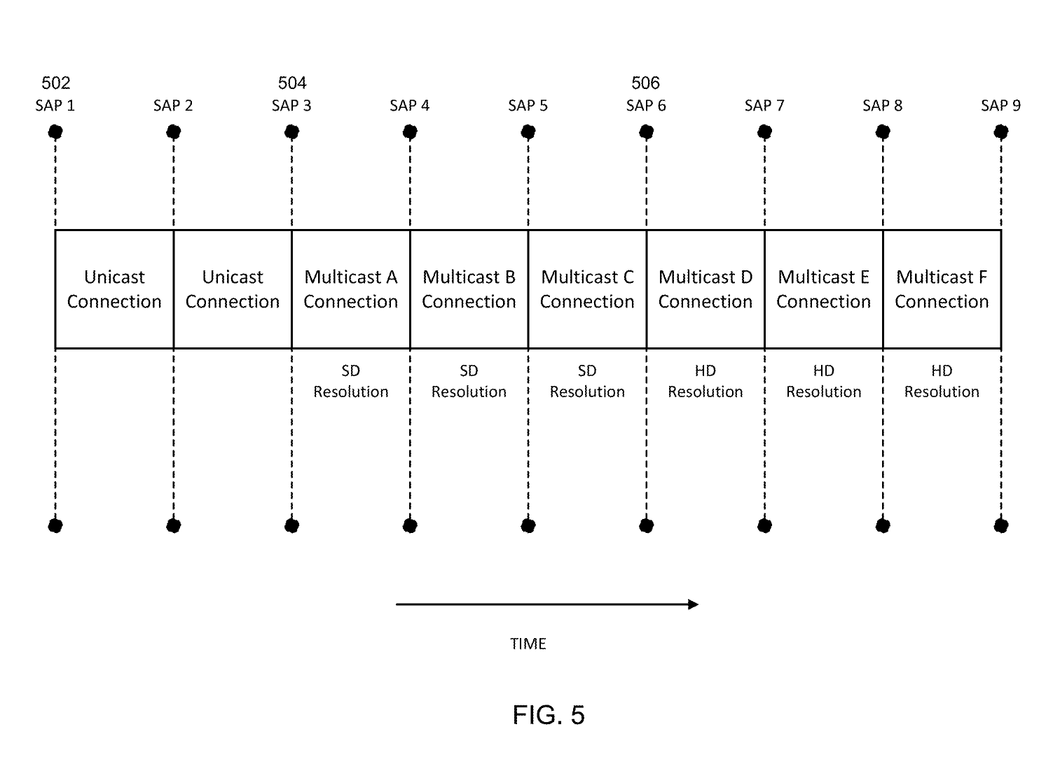

FIG. 5 illustrates changing between a unicast connection and a plurality of SD and HD multicast connections. At SAP 1 (502), the UE or client can receive the media stream via a unicast connection. At SAP 3 (504), the UE or client can stop receiving the media stream via the unicast connection and begin receiving the media stream via a plurality of SD resolution multicast connections. At SAP 6 (506), the UE or client can stop receiving the media stream via the SD resolution multicast connections and begin receiving the media stream via a plurality of HD resolution multicast connections.

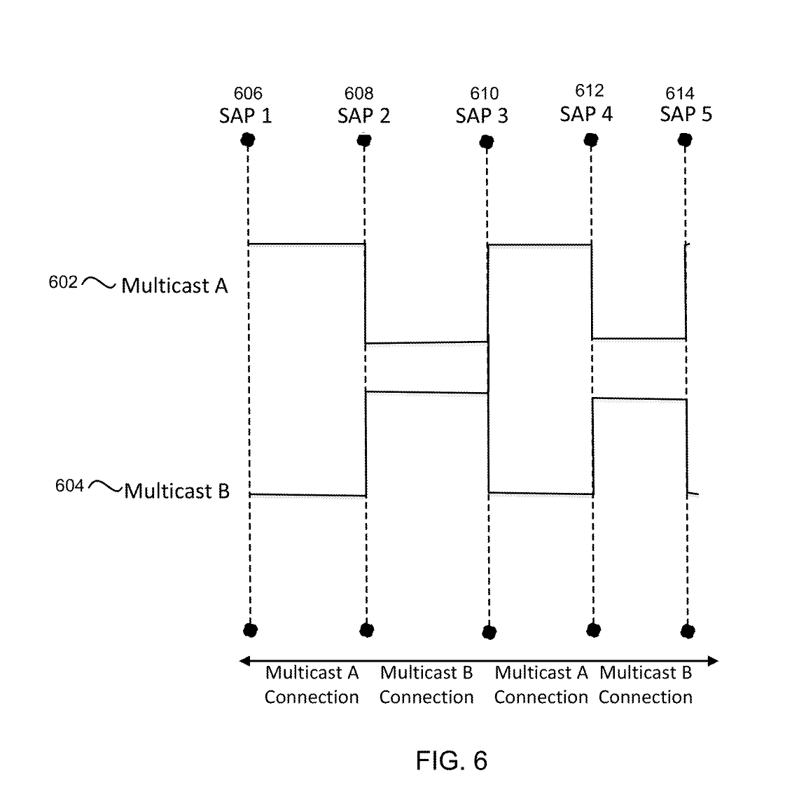

In another embodiment, FIG. 6 illustrates changing between two multicast connections, multicast connection A 602 and multicast connection B 604. Between SAP 1 (606) and SAP 2 (608), the UE or client can receive the media stream via multicast connection A 602. Between SAP 2 (608) and SAP 3 (610), multicast connection A 602 idles while the UE or client receives the media stream via multicast connection B 604. Between SAP 3 (610) and SAP 4 (612), multicast connection B 604 idles while the UE or client receives the media stream via multicast connection A 602. Between SAP 4 (612) and SAP 5 (614), multicast connection A 602 idles while the UE or client receives the media stream via multicast connection B 604. In this embodiment, while the client or user device receives streaming data or multimedia content via one multicast connection the other multimedia connection remains idle. In another embodiment of the invention, a plurality of multicast connections may sit idle while the client or user devices receives streaming data or multimedia content from a multicast connection.

In one embodiment, a broadcast multicast service center (BMSC) server can use one or more of the plurality of eMBMS/FLUTE sessions to transmit data for a predetermined period of time at any point in time. Such eMBMS sequencing over multiple eMBMS/FLUTE sessions allows the BMSC to alternatingly transmit data over the various eMBMS/FLUTE sessions. In one embodiment, the switching between the broadcast and eMBMS/FLUTE sessions as well as the switching between the first and second eMBMS/FLUTE sessions occurs at specific SAPs.

In one embodiment, a service provider or server can synchronize sending certain DASH-formatted components such as representations and segments over broadcast and sending other components over unicast. Alternatively, a client can synchronize receiving certain DASH-formatted components such as representations and segments over broadcast and receiving other components over unicast. Where DASH-formatted content may be received from different unicast/HTTP and/or broadcast/FLUTE delivery options, there may be a delay or temporal difference in sending and/or receiving the content. In synchronizing the content, a client and/or a server may consider and adjust for the difference in delay for receiving or sending content over unicast/HTTP and over eMBMS/FLUTE to avoid interruptions of media playback and to ensure continuity and consistent user experience for the entire content streaming. In one embodiment, continuity and consistency for the user is the ability to display the streaming multimedia content and/or data on the UE and change between unicast and eMBMS connections without the user noticing a significant change. A significant change is a change that reduces the viewing quality of the streaming multimedia content to an ordinary person.

Using SAPs for switching between unicast and eMBMS-based content delivery, the service provider may synchronize the unicast and eMBMS-based content and guide the client to switch at certain SAPs during in the media presentation. By guiding the DASH client, the service provider is able to provide seamless switching between unicast and broadcast delivery modes, and thereby ensure interrupt-free playback of the content. The SAP information may be included in a DASH MPD or an eMBMS user service description (USD).

In one embodiment the service provider may define or select at least one specific SAP as the point to switch between a given unicast/HTTP session and a given eMBMS/FLUTE session. By defining or selecting at least one specific SAP, seamless delivery of DASH-formatted content switching occurs while switching between a given unicast/HTTP session and a given eMBMS/FLUTE session. In one embodiment, the service provider may send different versions of the DASH-formatted content or representations over a given eMBMS/FLUTE session in order to compensate or account for the delay/timelines associated with switching at the SAPs.

In one embodiment of the invention, a client operating on a UE can seamlessly switch from initially receiving streaming data over a unicast/HTTP session to receiving the data from a plurality of eMBMS/FLUTE sessions at the same time. In another embodiment of the invention, a client can seamlessly switch from initially receiving data over a unicast/HTTP session to receiving the data sequentially or consecutively over one or more eMBMS/FLUTE sessions.

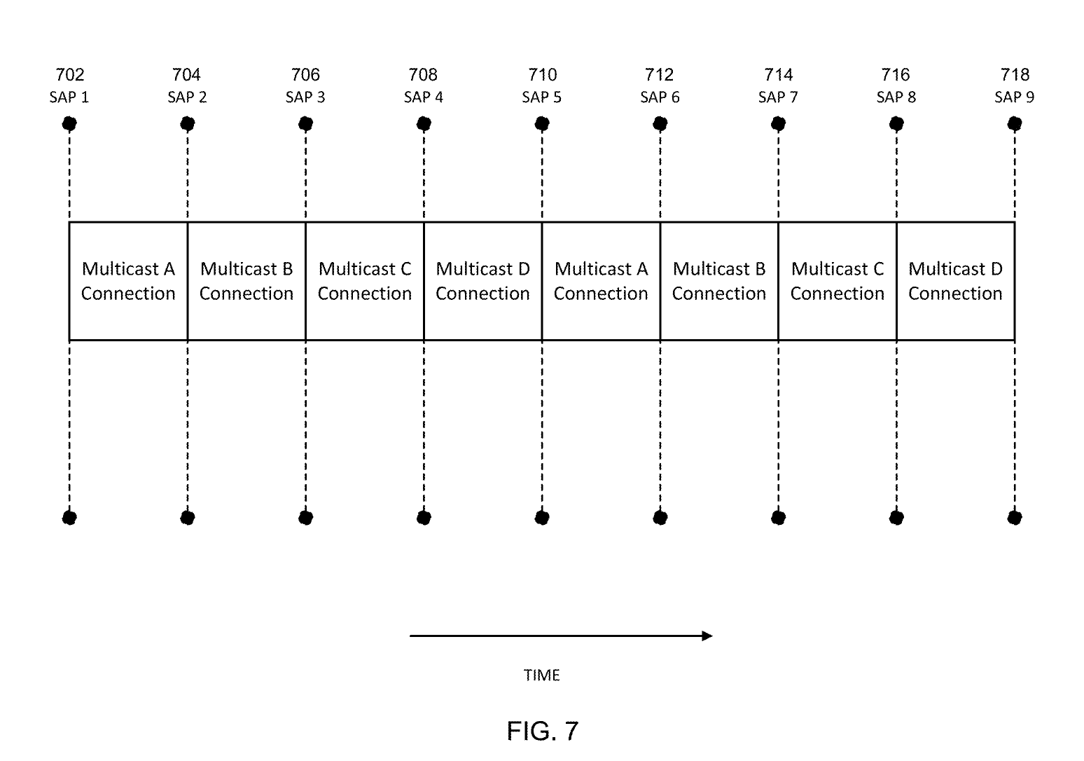

FIG. 7 illustrates changing between a plurality of multicast connections. At SAP 1 (702), the UE or client can receive the media stream via unicast connection A. At SAP 2 (704), the UE or client can stop receiving the media stream via the multicast connection A and begin receiving the media stream via the multicast connection B. At SAP 3 (706), the UE or client can stop receiving the media stream via the multicast connection B and begin receiving the media stream via the multicast connection C. At SAP 4 (708), the UE or client can stop receiving the media stream via the multicast connection C and begin receiving the media stream via the multicast connection D. At SAP 5 (710), the UE or client can stop receiving the media stream via the multicast connection D and begin receiving the media stream via the multicast connection A. At SAP 6 (712), the UE or client can stop receiving the media stream via the multicast connection A and begin receiving the media stream via the multicast connection B. At SAP 7 (714), the UE or client can stop receiving the media stream via the multicast connection B and begin receiving the media stream via the multicast connection C. At SAP 8 (716), the UE or client can stop receiving the media stream via the multicast connection B and begin receiving the media stream via the multicast connection C. At SAP 9 (718), the UE or client can stop receiving the media stream via the multicast connection C and begin receiving the media stream via the multicast connection D. In another embodiment the UE or client may switch between a plurality of multicast connection in any order or sequence.

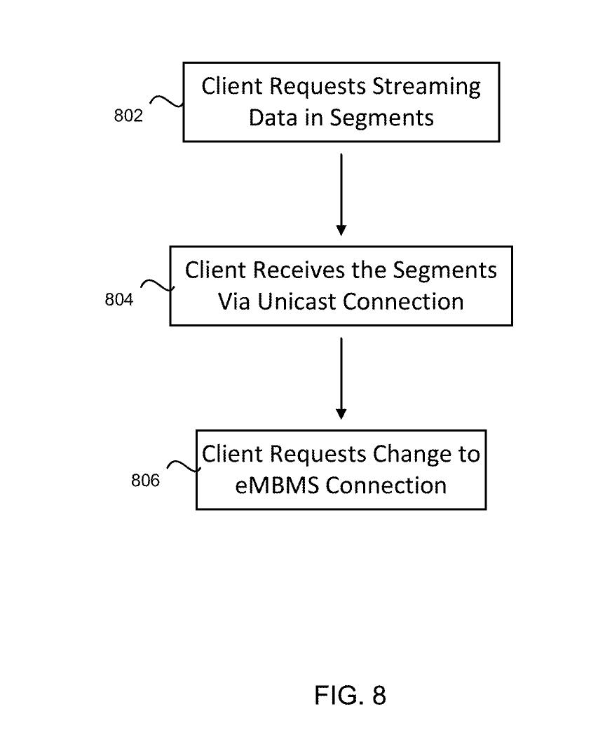

FIG. 8 depicts a process for switching between unicast and multicast streaming in a wireless communication. In the process, a DASH client operating on a UE can receive streaming data. At step 802, the DASH client requests the streaming data in segments from an HTTP server. At step 804, the DASH client receives the segments from the HTTP server via a unicast connection. In another embodiment the DASH client may receive the segments from the HTTP server via one of a unicast connection and an eMBMS via at least one evolved Node B (eNodeB). At step 806, the DASH client requests a change between the unicast connection and the eMBMS connection at a SAP of the streaming data.

In one embodiment, the DASH client can be configured to receive synchronization information from the HTTP server and determine at which SAP to change from the unicast session to the eMBMS session based on synchronization information. In another embodiment, synchronization data contains at least one HTTP-eMBMS synchronization SAP received in a DASH MPD to provide a synchronized point in streaming data between the unicast connection with the eMBMS connection. In another embodiment, a SAP occurs between two segments received from a HTTP server. In another embodiment, the DASH client is configured to receive a plurality of segments of different data formats over an eMBMS connection.

In another embodiment, the DASH client can be configured to receive at least one component of streaming data from the unicast connection and at least one component of streaming data from the eMBMS connection. In another embodiment, the DASH client is configured to receive a plurality of segments via an eMBMS connection based on eMBMS sequencing data. In another embodiment, the DASH client is configured to receive segments from a plurality of alternating eMBMS sessions. In another embodiment, the DASH client is configured to seamlessly receive a first segment from a unicast connection and a second segment from an eMBMS connection. In another embodiment, the DASH client is configured to playback a first segment from a unicast connection and a second segment from an eMBMS connection while providing continuity for the user. In another embodiment, the DASH Client is configured to receive eMBMS sequencing data and change between a plurality of eMBMS connections based on the eMBMS sequencing data.

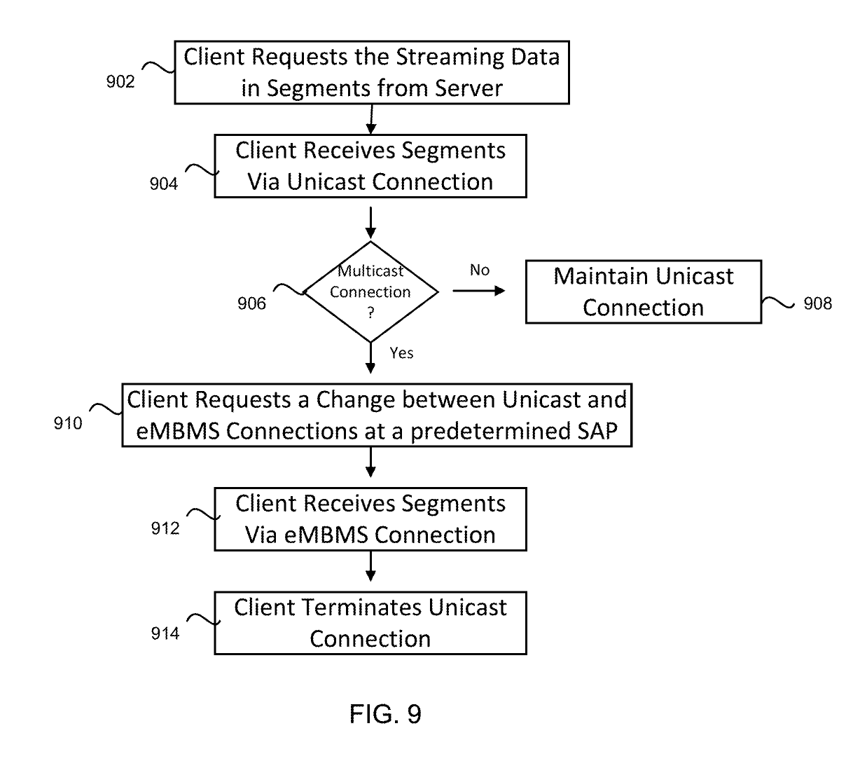

FIG. 9 depicts one embodiment of the present invention for switching from receiving a media stream over a unicast connection to receiving the media stream over a multicast connection at a DASH client operating on a UE. In step 902, the DASH client requests the streaming data in segments from a server. At step 904, the DASH client receives the segments from the HTTP server via a unicast connection. In another embodiment the DASH client may receive the segments from the HTTP server via one of a unicast connection and an eMBMS with at least one evolved Node B (eNodeB). In step 906 the DASH client determines if a multicast connection is available at a predetermined SAP or the next SAP. If a multicast connection is not available, then the DASH client maintains the unicast connection at step 908. If a multicast connection is available at the predetermined or next SAP, then in step 910 the DASH client requests to change from the unicast connection to the eMBMS connection at the predetermined or next SAP. In step 912, the DASH client receives the data segments via the eMBMS connection. In step 914, the DASH client terminates the unicast connection.

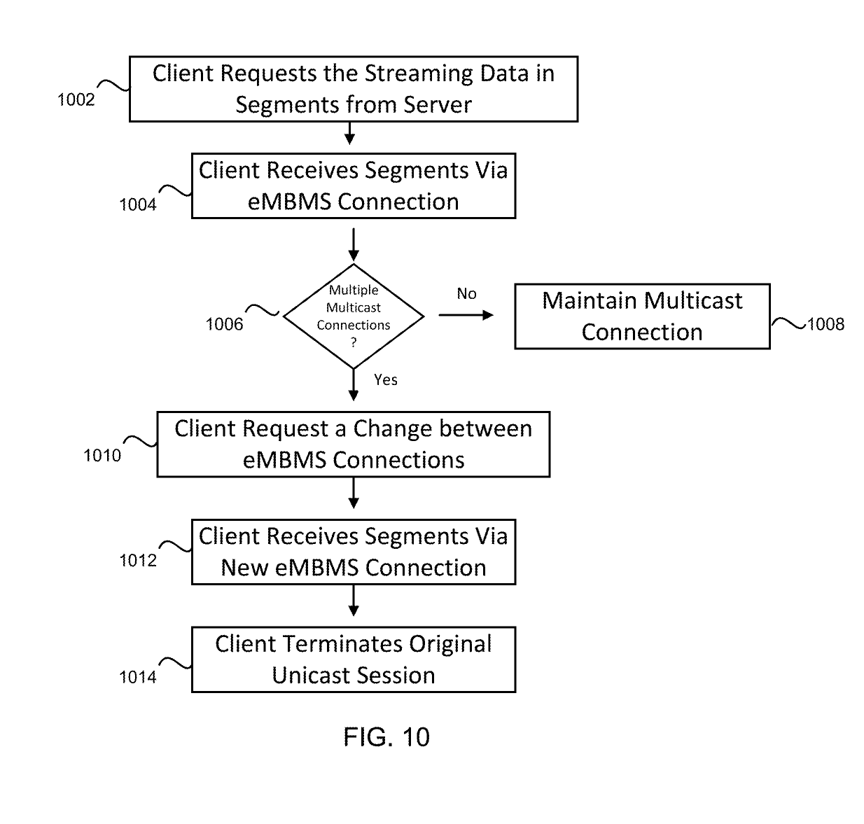

FIG. 10 depicts another embodiment of the present invention in a flow chart illustrating the switching from receiving a media stream over a multicast connection to receiving the media stream over a different multicast connection at a DASH client. In step 1002, the DASH client requests the streaming data in segments from a server. At step 1004, the DASH client receives the segments from the server via an eMBMS connection with at least one eNodeB. In step 1006, the DASH client determines if a second eMBMS connection is available at a predetermined or next SAP. If an additional eMBMS connection is not available, then the DASH client maintains the original eMBMS connection at step 1008. If a second eMBMS connection is available at the predetermined or next SAP, then in step 1010 the DASH client requests to change from the original eMBMS connection to the second eMBMS connection at the predetermined or next SAP. In step 1012, the DASH client receives the data segments via the second eMBMS connection. In step 1014, the DASH client terminates the original eMBMS connection.

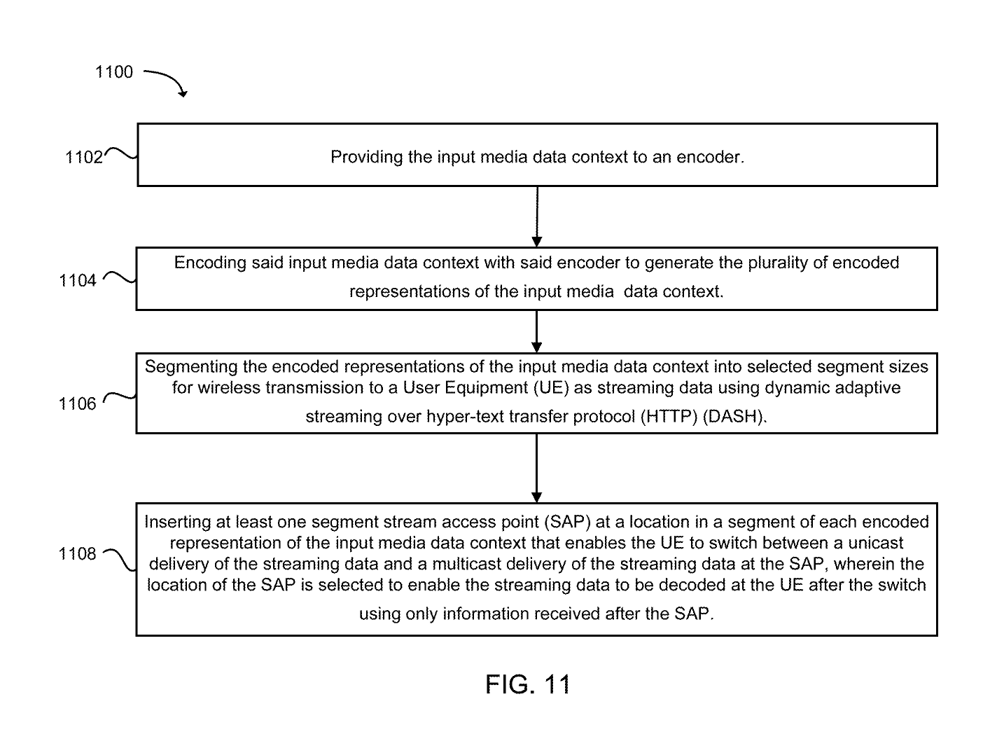

FIG. 11 illustrates a method 1100 for inserting stream access points (SAP) into a plurality of encoded representations of an input media data context. As used herein, the term “input media data context” comprises an input media sequence. In one embodiment, the input media sequence can comprise frames or other selected portions of digital video. In another embodiment, the input media sequence can comprise digital audio. The digital video and digital audio can be configured to allow the audio and/or video sequence to be streamed over a wireless connection, as can be appreciated. The input media sequence can also comprise both digital video and digital audio that can be streamed over a wireless connection.

The method 1100 comprises providing the input media data context to an encoder, as shown in block 1102. The input media data context can be encoded with the encoder to generate the plurality of encoded representations of the input media data context, as shown in block 1104. At least a portion of the input media data context can be included in a first encoded representation of the plurality of encoded representations. The same portion can also be included in a second encoded representation of the plurality of encoded representations. The first encoded representation can be encoded to a different set of encoding parameters than the encoding parameters used for the second encoded representation.

The method 1100 further comprises segmenting the encoded representations of the input media data context into selected segment sizes for wireless transmission to a user equipment (UE) as streaming data using dynamic adaptive streaming over hyper-text transfer protocol (HTTP) (DASH), as shown in block 1106. At least one stream access point (SAP) can be inserted at a location in a segment of each encoded representation of the input media data context that enables the UE to switch between a unicast delivery of the streaming data and a multicast delivery of the streaming data at the SAP, as shown in block 1108. The location of the SAP can be selected to enable the streaming data to be decoded at the UE after the switch using only information received after the SAP.

In one example, the SAP can enable the UE to maintain playback of input media data context after unicast-broadcast switching using initialization data contained in the segment to reduce any discontinuities or playback interruption caused by switching. In another example, information on the location of the at least one SAP in the encoded representations is signaled to the UE prior to transmission of the encoded representations. In one example, the different encoded representations of the input media data context include encoding the data with different bitrates, frame rates, resolutions, or codec types.

In one example, the location of the at least one SAP can be dynamically generated and updated in media segments that are to be sent to a live presentation. The updated locations can be signaled to the UE prior to the transmission of the encoded representations. In another example, the at least one SAP location of different encoded representations can be selected to be at a same location relative to a selected video frame in each encoded representation. Alternatively, the at least one SAP location of different encoded representations can be selected to be at a selected media time in each encoded representation. Placing the at least one SAP location at the same location in each different encoded representation, whether it is relative to a specific video frame or a selected media time, allows client operating on the UE to switch between the different encoded representations at the SAP locations while maintaining the continuity of the media displayed at the UE. In another example, the input media data context and the location information for the at least one SAP can be stored on a plurality of servers for transmission to the UE using DASH and using one of the unicast delivery and the multicast delivery.

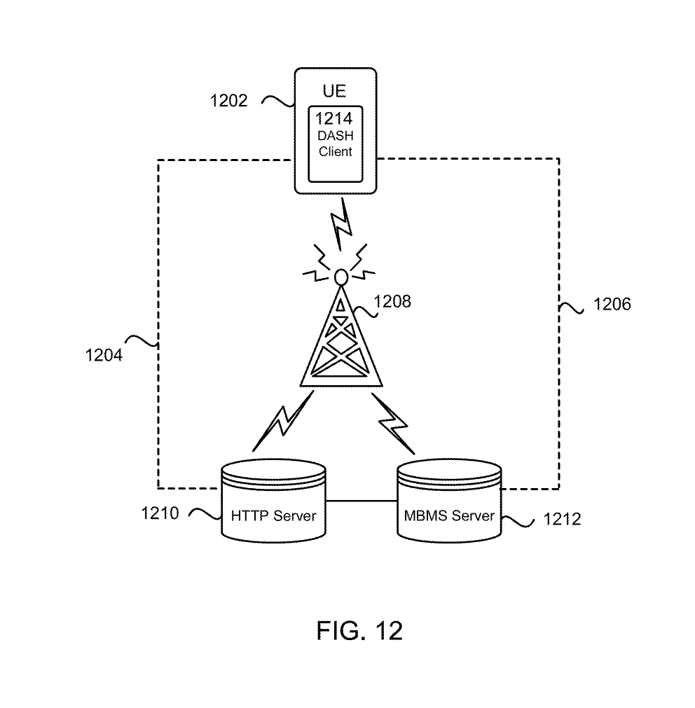

FIG. 12 illustrates an example of a communication between a user equipment (UE) and unicast and multicast servers. In this embodiment of the invention, the DASH Client 1214 operating on the UE 1206, can directly or indirectly receive the streaming media content from a plurality of servers. In one embodiment, the DASH Client 1214 may receive streaming media content directly via a unicast connection 1204 between the DASH Client 1214 and the HTTP server 1210. In another embodiment, the DASH Client 1214 may receive streaming media content directly via a multicast connection 1206 between the DASH Client 1214 and the MBMS server 1212. In another embodiment of the invention, the DASH Client 1214 may receive streaming media content indirectly via an intermediate connection 1208, where the HTTP server 1210 and/or the MBMS server 1212 transmit the streaming media content through the intermediate connection 1208 to the DASH Client 1214.

The intermediate connection 1208 can be a node. In 3GPP radio access network (RAN) LTE systems, the node can be a combination of Evolved Universal Terrestrial Radio Access Network (E-UTRAN) Node Bs (also commonly denoted as evolved Node Bs, evolved Node Bs, eNodeBs, or eNBs) and Radio Network Controllers (RNCs), which communicates with the UE. A downlink (DL) transmission can be a communication from the node (e.g., eNodeB) to the wireless device (e.g., UE), and the uplink (UL) transmission can be a communication from the wireless device to the node. The node can include a base station (BS), a Node B (NB), an eNB, a baseband unit (BBU), a remote radio head (RRH), a remote radio equipment (RRE), a remote radio unit (RRU), or a central processing module (CPM).

In one embodiment of the communication system between a UE and unicast and multicast servers, the communication system for content streaming comprises: (1) an HTTP server 1210 transmitting data over a unicast session, where the unicast session transmits one or more SAPs for switching between unicast and eMBMS delivery (e.g., in the DASH MPD); (2) the HTTP server 1210 responsive to a request from the DASH client 1214 to stop transmitting the data over the unicast session at a next SAP configured to allow switching between unicast and multicast streaming; and (3) a BMSC or MBMS server 1212 transmitting the data over a plurality of synchronized eMBMS/FLUTE sessions, with the BMSC or MBMS server 1212 sequencing the transmission of the data in accordance with the eMBMS sequencing data between the plurality of eMBMS/FLUTE sessions.

While the HTTP server 1210 and the MBMS server 1212 are illustrated as being two different servers, this is not intended to be limiting. The HTTP unicast connection and the eMBMS multicast connection with the client 1214 operating on the UE 1202 may originate from different servers, as shown in FIG. 12 or from the same server. Alternatively, a single server may be used to virtually host separate servers on the same physical device.

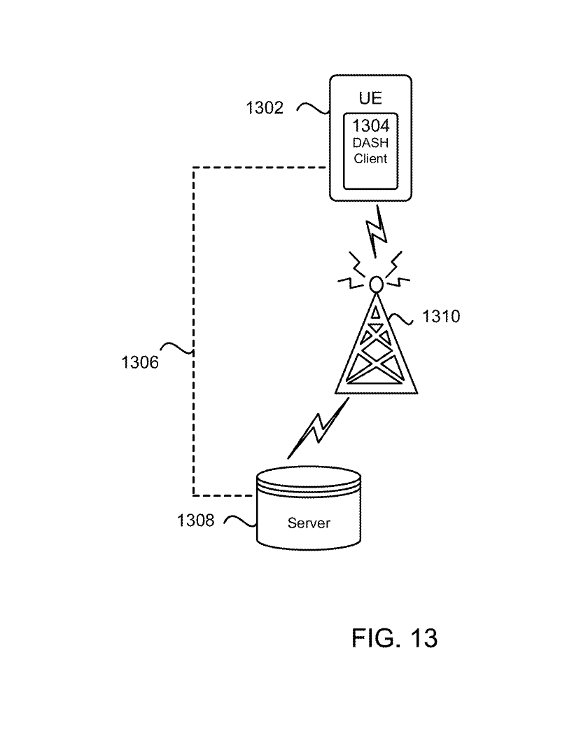

For example, FIG. 13 illustrates an embodiment of a communication between a server such as a multimedia or data server and a user equipment (UE). In this embodiment of the invention the DASH Client 1304 of the UE 1302 may directly or indirectly wirelessly receive the streaming media content from the server 1308. In one embodiment, the DASH Client 1304 may receive streaming media content wirelessly from a unicast or multicast connection 1306 between the DASH Client 1304 and the server 1308. In another embodiment of the invention, the DASH Client 1304 may receive streaming media content wirelessly indirectly via an intermediate connection 1310 such as an eNodeB or other type of node, wherein the server 1308 transmits the streaming media content through the intermediate connection 1310 to the DASH Client 1304.

In one embodiment, the server 1308 may be a virtual server or a cloud server. In another embodiment, the server may store one or more representations of multimedia content or other types of streaming data for broadcast, multicast, or unicast communication to the dash client 1304 operating on the UE 1302.

In one embodiment, the DASH Client 1304, operating on the UE 1302, is configured to request the streaming data in segments from a DASH content server 1308. The DASH client can receive the segments from the DASH content server via one of a unicast connection and an evolved multimedia broadcast and multicast services (eMBMS) connection with at least one evolved Node B (eNodeB). The DASH client can request a change between the unicast connection and the eMBMS connection at a stream access point (SAP) of the streaming media.

In one embodiment, the DASH client is further configured to receive synchronization information from the DASH content server; and determine at which SAP to change from the unicast session to the eMBMS session based on the synchronization information.

The synchronization data can contain at least one unicast eMBMS synchronization SAP received in a DASH Media Presentation Description (MPD) to provide a synchronized point in the streaming media between the unicast connection and the eMBMS connection to maintain continuous playback of media. In one embodiment, the SAP in the streaming media can occur at a border between two segments received from the DASH content server.

In another embodiment, the DASH client can be further configured to perform a unicast-to-broadcast switch to, and receive a plurality of segments from, multiple file delivery over unidirectional transport (FLUTE) sessions over the eMBMS connection.

In one embodiment, the DASH client can be further configured to receive at least one component of the streaming media from the unicast connection and at least one component of the streaming media from the eMBMS connection.

In another embodiment, the DASH client is further configured to receive a plurality of segments over multiple file delivery over unidirectional transport (FLUTE) sessions via the eMBMS connection based on eMBMS sequencing data. The DASH client can receive the segments from a plurality of alternating eMBMS sessions. The DASH client can seamlessly receive a first segment from the unicast connection and a second segment from the eMBMS connection.

In one embodiment, the DASH client can playback a first segment form the unicast connection and a second segment from the eMBMS connection while providing continuity for the user. The DASH client can receive eMBMS sequencing data and change between a plurality of eMBMS connections based on the eMBMS sequencing data.

The SAPs in the streaming media can be dynamically generated and communicated to the UE to provide updated SAP locations so that the UE can request the change between the unicast connection and the eMBMS connection at the SAP location.

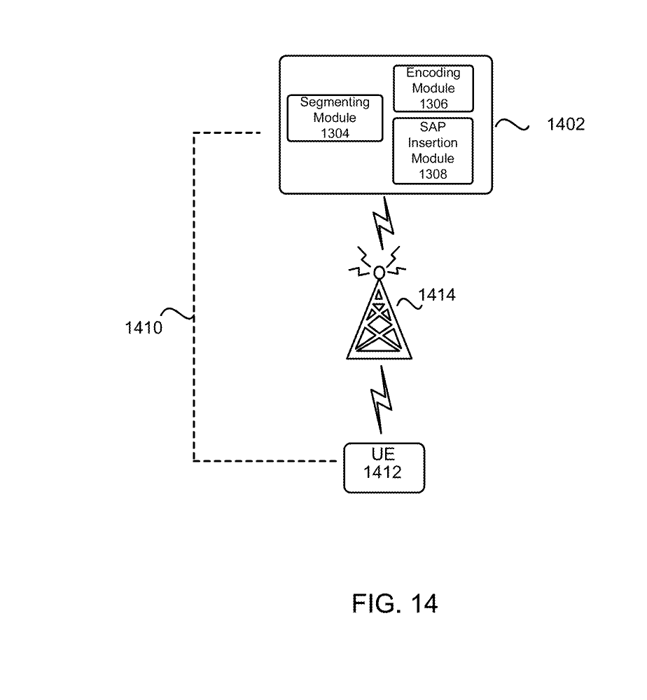

FIG. 14 illustrates an example of a media server 1402 configured to provide a UE 1412 with streaming multimedia content. In this example, the media server comprises a segmenting module 1404, an encoding module 1406, and a SAP insertion module 1408. The segmenting module 1404 is configured to segment the encoded representations of the input media data context into selected segment sizes for transmission to a UE 1412 as streaming multimedia content.

The encoding module 1406 is configured to receive an input media data context and encode the input media data context to generate a plurality of encoded representations of the input media data context. At least a portion of the input media data context is included in a first encoded representation of the plurality of encoded representations and the same portion is also included in a second encoded representation of the plurality of encoded representations. The first encoded representation is encoded according to a different set of encoding parameters than is the second encoded representation.

The SAP insertion module 1408 is configured to insert at least one SAP at a location in a segment of each of the encoded representations of the input media data context that enables the UE 1412 to switch between a unicast delivery of the streaming multimedia content and a multicast delivery of the streaming multimedia content at the SAP. Additionally, the location of the SAP may be selected to enable the streaming multimedia content to be decoded at the UE 1412 after the switch using only information received after the SAP. In one embodiment, the UE 1412 may receive streaming media content wirelessly from directly via a unicast or multicast connection 1410 between the UE 1412 and the media server 1402. In another embodiment of the invention, the UE 1412 may receive streaming media content wirelessly from indirectly via an intermediate connection 1414, where the media server 1402 transmits the streaming media content through the intermediate connection 1414 to the UE 1312.

In another embodiment, each of the unicast and eMBMS/FLUTE sessions are independent sessions that may be connected to and decoded by a client. In one embodiment, the SAPs are synchronized or aligned at the same content points of different sessions. As each session is independent, the client does not need to have received or know what occurred during the previous sessions. In one embodiment, the length of time to switch between sessions depends on how the content is encoded. In one embodiment, the length of time for switching between sessions, i.e. the switching time, using SAPs for content with 30 frames per second may be 15 frames. The encoding of the sessions is temporally correlated, thus requiring that certain frames are decoded before decoding other frames. In one example, the time required for decoding and switching sessions is approximately one half of a second. In another one embodiment, the eMBMS sequencing data can be transmitted in the DASH MPD. In still a further aspect of the embodiment, the eMBMS sequencing data may be transmitted at periodic intervals.

In another embodiment, the media server is configured to provide the streaming multimedia content for transmission to a UE using one of a hyper-text transfer protocol (HTTP) server over a unicast connection and a file delivery over unidirectional transport (FLUTE) server over an evolved multimedia broadcast and multicast services (eMBMS) connection with at least one eNodeB.

In another embodiment, the media server is further configured to provide a first segment of the multimedia content for transmission to a UE using a unicast connection and a second segment of the multimedia content using an evolved multimedia broadcast and multicast services (eMBMS) connection.

In another embodiment, the media server is configured to provide different encoded representations of the input media data context for transmission over different file delivery over unidirectional transport (FLUTE) sessions with at least one SAP provided at a location in a segment of each of the encoded representations of the input media data context.

In another embodiment, the media server is configured to provide a first segment of the multimedia content over unicast via a hyper-text transfer protocol (HTTP) server and to provide a second segment of the multimedia content over an evolved multimedia broadcast and multicast services (eMBMS) connection via a broadcast multicast service center (BMSC) server.

In another embodiment, the media server is configured to sequence the transmission of the segments based on MBMS sequencing data. In another embodiment, the media server is configured to stop providing the first segment of the multimedia content over the unicast session at a unicast-MBMS synchronization SAP.

In another embodiment unicast SAPs and eMBMS SAPs are used for seamless switching from initially receiving data over a unicast/HTTP session to receiving the data over a plurality of synchronized eMBMS/FLUTE sessions is enabled. Seamlessly switching allows a UE to seamlessly receive data without missing a frame of the streaming data. In this embodiment, seamless switching from a unicast delivery to eMBMS delivery is accomplished using an eMBMS sequencing framework. In this embodiment, the client receives the first part of the data over the unicast/HTTP session and receives the second part of the data over the plurality of synchronized eMBMS/FLUTE sessions, where the client receives data across alternating eMBMS/FLUTE sessions based on the eMBMS sequencing framework. The seamless switching is enabled by the plurality of sequenced eMBMS/FLUTE sessions that are synchronized such that one of the plurality of eMBMS/FLUTE sessions transmits a portion of the second data for a predetermined period of time at any point in time and another one of the plurality of eMBMS/FLUTE sessions transmits a subsequent portion of the second data. The client can tune in to the synchronized sequence, thereby preserving the continuity of the DASH streaming.

In another embodiment, SAPs for unicast-broadcast switching are included in the DASH MPD and may contain with the eMBMS sequencing information. Alternatively, sequencing or switching information could also be included in eMBMS user service description (USD). In one embodiment of the invention, unicast-broadcast switching SAPs could coincide with the existing DASH-level SAPs for random access between different DASH representations. SAP information may also be carried inside the UE over an interface between the DASH client and eMBMS/FLUTE client.

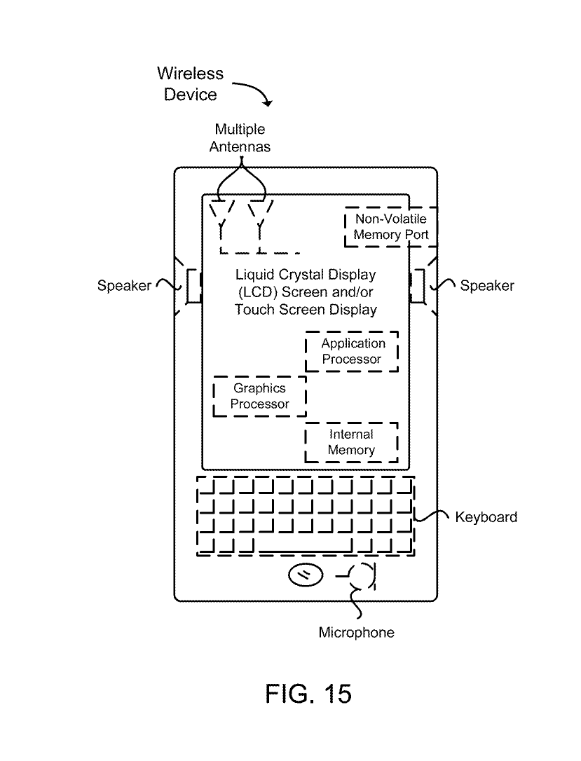

In another example, a transmission station can be in wireless communication with a mobile device. FIG. 15 provides an example illustration of the mobile device, such as a user equipment (UE), a mobile station (MS), a mobile wireless device, a mobile communication device, a tablet, a handset, or other type of mobile wireless device. The mobile device can include one or more antennas configured to communicate with a node, macro node, low power node (LPN), or, transmission station, such as a base station (BS), an evolved Node B (eNB), a base band unit (BBU), a remote radio head (RRH), a remote radio equipment (RRE), a relay station (RS), a radio equipment (RE), or other type of wireless wide area network (WWAN) access point. The mobile device can be configured to communicate using at least one wireless communication standard including 3GPP LTE, WiMAX, High Speed Packet Access (HSPA), Bluetooth, and WiFi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 15 also provides an illustration of a microphone and one or more speakers that can be used for audio input and output from the mobile device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The base station and mobile station may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for inserting stream access points (SAP) into a plurality of encoded representations of an input media data context, the method comprising:
providing the input media data context to an encoder;
encoding said input media data context with said encoder to generate the plurality of encoded representations of the input media data context, wherein at least a portion of the input media data context is included in a first encoded representation of said plurality of encoded representations and the same portion is also included in a second encoded representation of said plurality of encoded representations, and said first encoded representation is encoded according to a different set of encoding parameters than is said second encoded representation;
segmenting the encoded representations of the input media data context into selected segment sizes for wireless transmission to a User Equipment (UE) as streaming data using dynamic adaptive streaming over hyper-text transfer protocol (HTTP) (DASH); and
inserting at least one stream access point (SAP) at a location in a segment of each encoded representation of the input media data context that enables the UE to switch between a unicast delivery of the streaming data and a multicast delivery of the streaming data at the SAP, wherein the location of the SAP is selected to enable the streaming data to be decoded at the UE after the switch using only information received after the SAP.

2. The method of claim 1, wherein the SAP enables the UE to maintain playback of the input media data context after unicast-broadcast switching using initialization data contained in the segment to reduce discontinuities or playback interruptions caused by the unicast-broadcast switching.

3. The method of claim 1, wherein information on the location of the at least one SAP in the encoded representations is signaled to the UE prior to a transmission of the encoded representations.

4. The method of claim 3, wherein the different encoded representations of the input media data context include encoding the data with different bitrates, frame rates, resolutions, or codec types.

5. The method of claim 3, the method further comprising dynamically generating and updating the location of the at least one SAP in media segments to be sent in a live presentation and signaling these updates to the UE prior to the transmission of the encoded representations.

6. The method of claim 3, wherein the at least one SAP location of different encoded representations is selected to be at a same location relative to a selected video frame or a selected media time in each encoded representation.

7. The method of claim 1, the method further comprising storing the input media data context and the location information for the at least one SAP on a plurality of servers for transmission to the UE using DASH and using one of the unicast delivery and the multicast delivery.

8. A media server operable to provide a User Equipment (UE) with streaming multimedia content, the media server comprising:
an encoding module configured to receive an input media data context and encode said input media data context to generate a plurality of encoded representations of the input media data context, wherein at least a portion of the input media data context is included in a first encoded representation of said plurality of encoded representations and the same portion is also included in a second encoded representation of said plurality of encoded representations, and said first encoded representation is encoded according to a different set of encoding parameters than is said second encoded representation;
a segmenting module configured to segment the encoded representations of the input media data context into selected segment sizes for transmission to a User Equipment (UE) as streaming multimedia content; and
a stream access point (SAP) insertion module configured to insert at least one SAP at a location in a segment of each of the encoded representations of the input media data context that enables the UE to switch between a unicast delivery of the streaming multimedia content and a multicast delivery of the streaming multimedia content at the SAP, wherein the location of the SAP is selected to enable the streaming multimedia content to be decoded at the UE after the switch using only information received after the SAP.

9. The media server of claim 8, wherein the media server is further configured to provide the streaming multimedia content for transmission to a UE using one of a hyper-text transfer protocol (HTTP) server over a unicast connection and a file delivery over unidirectional transport (FLUTE) server over an evolved multimedia broadcast and multicast services (eMBMS) connection with at least one evolved Node B (eNodeB).

10. The media server of claim 8, wherein the media server is further configured to provide a first segment of the multimedia content for transmission to a UE using a unicast connection and a second segment of the multimedia content using an evolved multimedia broadcast and multicast services (eMBMS) connection.

11. The media server of claim 8, wherein the media server is further configured to provide different encoded representations of the input media data context for transmission over different file delivery over unidirectional transport (FLUTE) sessions with at least one SAP provided at a location in a segment of each of the encoded representations of the input media data context.

12. The media server of claim 8, wherein the media server is further configured to provide a first segment of the multimedia content over unicast via a hyper-text transfer protocol (HTTP) server and to provide a second segment of the multimedia content over an evolved multimedia broadcast and multicast services (eMBMS) connection via a broadcast multicast service center (BMSC) server.

13. The media server of claim 12, wherein the media server is further configured to sequence the transmission of the segments based on MBMS sequencing data.

14. The media server of claim 12, wherein the media server is further configured to stop providing the first segment of the multimedia content over the unicast session at a unicast-MBMS synchronization SAP.

15. A User Equipment (UE) operable to receive streaming media in a dynamic adaptive streaming over hyper-text transfer protocol (HTTP) (DASH) format comprising:
a DASH client operating on the UE that is configured to:
request the streaming data in segments from a DASH content server;
receive the segments from the DASH content server via one of a unicast connection and an evolved multimedia broadcast and multicast services (eMBMS) connection with at least one evolved Node B (eNodeB); and
request a change between the unicast connection and the eMBMS connection at a stream access point (SAP) of the streaming media.

16. The UE of claim 15, wherein the DASH client is further configured to:
receive synchronization information from the DASH content server; and
determine at which SAP to change from the unicast session to the eMBMS session based on the synchronization information.

17. The UE of claim 16, wherein the synchronization data contains at least one unicast-eMBMS synchronization SAP received in a DASH Media Presentation Description (MPD) to provide a synchronized point in the streaming media between the unicast connection and the eMBMS connection to maintain continuous playback of media.

18. The UE of claim 15, wherein the SAP in the streaming media occurs at a border between two segments received from the DASH content server.

19. The UE of claim 15, wherein the DASH client is further configured to perform a unicast-to-broadcast switch to and receive a plurality of segments from multiple file delivery over unidirectional transport (FLUTE) sessions over the eMBMS connection.

20. The UE of claim 15, wherein the DASH client is further configured to receive at least one component of the streaming media from the unicast connection and at least one component of the streaming media from the eMBMS connection.

21. The UE of claim 15, wherein the DASH client is further configured to receive a plurality of segments over multiple file delivery over unidirectional transport (FLUTE) sessions via the eMBMS connection based on eMBMS sequencing data.

22. The UE of claim 15, wherein the DASH client is further configured to receive the segments from a plurality of alternating eMBMS sessions.

23. The UE of claim 15, wherein the DASH client is further configured to seamlessly receive a first segment from the unicast connection and a second segment from the eMBMS connection.

24. The UE of claim 23, wherein the DASH client is further configured to playback a first segment from the unicast connection and a second segment from the eMBMS connection while providing continuity for the user.

25. The UE of claim 15, wherein the DASH client is further configured to receive eMBMS sequencing data and change between a plurality of eMBMS connections based on the eMBMS sequencing data.

26. The UE of claim 15, wherein each SAP in the streaming media is dynamically generated and communicated to the UE to provide updated SAP locations so that the UE can request the change between the unicast connection and the eMBMS connection at a location of the SAP at future media segment receptions based on the updated SAP locations.
